(19) United States
(12) Patent Application Publication
(10) Pub. No.: US 2004/0209096 A1
(43) Pub. Date: Oct. 21, 2004

(54) Halftone image produced by printing

(76) Inventors: Ludwig Brehm, Adelsdorf (DE); Hannelore Erbar, Furth (DE)

Correspondence Address: Charles R Hoffmann, Hoffmann & Baron, 6900 Jericho Turnpike, Syosset, NY, 11791, US

(21) Appl. No.: 10/482,892

(22) PCT Filed: Jul. 3, 2002
(86) PCT No.: PCT/DE02/02414

(30) Foreign Application Priority Data
Jul. 25, 2001 (DE) 101 36 252.8

(51) Int. Cl. B32B 27/10

(52) U.S. Cl. 428/481

(57) ABSTRACT

It is proposed that colored halftone images are produced by using printing inks which contain fluorescent pigments so that the respective colors are produced by additive color mixing.

The invention concerns halftone images produced on a substrate by printing, comprising at least two kinds of image dots of different colors arranged in a raster-like manner, wherein the respectively desired color is produced by color mixing of the colors of the image dots.

In the case of colored halftone prints produced in conventional printing processes, for example offset printing, intaglio printing or thermotransfer printing, the color impression is produced by subtractive color mixing of four primary colors (generally cyan, yellow, magenta and black). In the case of halftone prints of that kind the pigments of the printing inks absorb the respective complementary component, from the incidence white light. The non-absorbed corresponding color component of the white light is reflected, reaches the eye of the viewer and there produces a corresponding color impression. Each of the primary colors therefore reflects only a portion of the incident light. The brightness of halftone prints produced in that way is dependent on the background on which the primary colors are printed. The lighter the background is, the correspondingly lighter is it possible to produce parts in the halftone image.

In contrast, on a television tube or a cinema screen images are produced by additive color mixing. In that case, virtually every point on the screen or television tube represents a small light source which is lit in a special color. if in that case, as is the situation for example with a TV tube, three quite specific regions of the visible spectrum are selected as colored light sources, for example red, green and blue-violet, which are distributed over the entire range of the visible spectrum and make it possible to stimulate the corresponding color receptors in the eye, it is thus possible by additive color mixing to produce colored images with realistic coloring.

As a prerequisite for additive color mixing is the presence of corresponding lighting pixels, hitherto it has been necessary to forego the use of additive color mixing in relation to printed halftone images.

Now, the object of the present invention is to propose a possible way of producing on a substrate by a printing process halftone images which are distinguished in relation to the previous halftone images by a high level of brilliance and the possibility of color production which is close to reality.

In accordance with the invention, to attain that object, it is proposed that a halftone image produced by printing is such that the image dots are formed by printing inks containing pigments which fluoresce in a given color upon excitation by means of electromagnetic radiation. Preferably halftone images according to the invention are produced in that case in such a way that there are provided image dots comprising three different printing inks, wherein the pigments of the various printing inks each fluoresce in a respective one of three primary colors (for example red, green and blue-violet) for additive color mixing because then virtually all colors of the visible spectrum can be produced by a corresponding combination of image dots of the individual, respectively differently fluorescing pigments.

Printed halftone images according to the invention therefore differ from the hitherto usual printed colored halftone images in that the respective colors are only recognisable when the pigments contained in the individual printing inks are excited by electromagnetic radiation of suitable wavelength and then fluoresce. As soon as the pigments are excited however a very brightly shining, highly colored halftone image is obtained. In that connection it is to be pointed out that the term ‘printing inks’ is obviously to be interpreted in the broadest sense and embraces all kinds of inks or lacquers which are suitable for producing a printing or raster image on a substrate. In particular ‘printing inks’ in accordance with the invention are also for example the lacquer or sublimation layers of thermotransfer or thermoprinting films.

A quite particular feature of the halftone images according to the invention is that the desired color or coloration can only be observed if the halftone image is irradiated with electromagnetic radiation of suitable wavelength. The consequence of this is that the color or coloring of the halftone image changes when it is irradiated with light of differing wavelength, for example on the one hand with visible light and on the other hand with ultraviolet light. It is possible to make use of that effect for example in order to represent on a substrate different patterns or images which are visible alternately depending on the respective wavelength or frequency of the electromagnetic radiation used for the lighting effect.

The most widely varying kinds of electromagnetic radiation can be provided for exciting the fluorescent pigments. In practice however it will generally be desirable to use pigments which fluoresce under the effect of UV-radiation.

It is further provided according to the invention that the image dots are arranged on a black background. In that case the black background can either be formed by the substrate directly. It would however also be possible for the black background to be formed by means of a suitable printing ink, in which case the printing ink forming the background can then be arranged over the entire surface area or however it can also be arranged only in intermediate spaces between the image dots which fluoresce in color.

In accordance with the invention particular effects can be achieved when at least one of the pigments used in the printing ink is so selected that it fluoresces in different colors under the effect of radiation of differing frequency. That then gives a different result, in dependence on the radiation used for illuminating the halftone image, depending on the color in which the corresponding pigment is just fluorescing, in which respect it is possible to achieve both color changes and also changes in the motif, in dependence on the frequency used for the irradiation procedure.

It is particularly advantageous if, according to the invention, the dimensions of the image dots—producing the halftone image—are so selected that they cannot be resolved with the naked eye, which at any event can be achieved if, in accordance with the invention, the dimensions of the image dots are selected to be smaller than 0.3 mm. In that case, the colored light beams coming from the individual image dots are mixed from the point of view of the viewer and that gives so-to-speak the impression of a continuous, correspondingly colored surface.

Special effects which are highly valuable for example for security purposes can be achieved if, in a development of the idea of the invention, provided on the substrate are on the one hand fluorescent image dots of printing inks containing pigments which fluoresce upon being excited with a given electromagnetic radiation and on the other hand non-fluorescent image dots of printing inks which contain colored pigments which do not fluoresce upon excitation with the given electromagnetic radiation. In that respect the term ‘image dots which do not fluoresce’ is not to be interpreted generally to mean that the printing inks serving to produce those image dots absolutely do not fluoresce. In connection with the present invention this may also involve image dots comprising printing inks, the pigments of which admittedly fluoresce upon being excited with certain electromagnetic radiations, but not upon being excited with the given electromagnetic radiation which causes the fluorescent image dots to fluoresce. If a halftone image is composed of fluorescent and non-fluorescent image dots in that way, then, in dependence on the irradiation, that gives a respectively differing effect as, upon irradiation with the electromagnetic radiation causing excitation of the fluorescent image dots, the fluorescent image dots correspondingly light up and produce a halftone color image while, upon being irradiated with a differing radiation, the so-called non-fluorescent pigments produce the halftone color image. In that way it is possible to provide for example that, upon irradiation with UV light, the effect of the fluorescent pigments produces a first color impression while, upon being lit with daylight and with a corresponding small amount of UV light, the color impression which is produced is different therefrom.

In principle it is possible for the fluorescent image dots on the one hand and the non-fluorescent image dots on the other hand each to be provided on the substrate in their own respective regions. In general terms however it is more appropriate if the fluorescent image dots on the one hand and the non-fluorescent image dots on the other hand are provided on the substrate in mutually nested relationship because then the differing effects which are respectively dependent on the lighting involved occur on the same surface region of the substrate which has both fluorescent and also non-fluorescent image dots.

It is further provided that the fluorescent image dots represent a first image and the non-fluorescent dots represent a second image. For example it would be possible in that way to provide a personal document with the portrait of the owner of the document, in duplicate, wherein the first document is represented as a normal halftone image by mixing of the colors cyan, magenta and yellow (and optionally black) while the second portrait is produced by additive color mixing from pigmented printing inks fluorescing for example under UV light. In that way it is possible to considerably enhance the security of a personal document and at the same time that gives a simple method of authenticity checking, more specifically insofar as it is only necessary to check whether the portrait of the owner of the document, which was produced by subtractive color mixing, is identical to the portrait which appears under irradiation with quite specific electromagnetic radiation and which is produced by positive color mixing from fluorescent inks. The production of such images from normal pigments involving subtractive color mixing and fluorescent pigments involving additive color mixing can be easily effected for example by means of thermotransfer printers which must then just be capable of providing correspondingly many colors for the printing dots.

Halftone images according to the invention can be used for the most widely varying purposes. However, particularly advantageous and subject-matter of the invention is the use of a corresponding halftone image as a security or guarantee element for valuables, documents, in particular value-bearing papers or bonds, banknotes and passes, or for correspondingly valuable articles. For example it would be possible for a banknote, a check or another value-bearing paper or bond to be provided with a suitable halftone print, in which case then the respectively desired color effect only occurs upon irradiation with suitable radiation. For example it would be possible to provide that a security element on a banknote or the like shows a specific color effect only when the banknote is irradiated with UV light of a given frequency while only a light gray shimmer is produced upon irradiation with normal light, without the contours or the like of the actually printed halftone image being recognisable with that kind of illumination. If the fluorescent pigments are suitably selected and possibly non-fluorescent pigments are additionally added to the printing inks, it is for example also possible to generate a halftone image which appears white or gray upon being illuminated with normal light and which, upon being illuminated with light of a specific wavelength, in particular UV light, exhibits powerful colors, as a consequence of the fluorescence effect which occurs. That effect (a change between a black-and-white representation and a colored representation) is highly suitable as an easily recognisable security element.

Particular safeguard effects can be achieved if, as discussed above, two images are combined on the document or the like, the first image being a normal halftone color image while the second image can be clearly recognised only as a consequence of fluorescence upon being illuminated with light or electromagnetic radiation of a specific wavelength, wherein the particular safeguard effect is to be seen in the possibility of providing two basically identical images which can then be suitably compared together.

In order to make it easier to apply corresponding security elements to valuables, it is advantageous if the halftone image is formed by the decorative layer of a transfer foil, in particular a hot stamping foil or thermotransfer foil, which decorative layer is transferred on to the article to be safeguarded. Halftone images can easily be produced using conventional printing processes as a constituent part of transfer foils and then transferred in a simple manner on to the articles to be safeguarded, in the form of label-like patches, stripes and so forth. That has the advantage that the user of corresponding security elements can obtain them in a more or less finished condition and then only requires a relatively simple device for transferring the security element from the transfer foil on to the article to be safeguarded.

Finally it is in accordance with the invention that, when using corresponding halftone images as a security element for articles, the halftone image is combined with an optically effective element, for example a grating structure, a hologram, a surface which reflects with a high shine, a deliberately matted region or a thin-layer arrangement which produces a color change or differing transparency.

The halftone images in accordance with the invention on their own can already only be copied with difficulty because difficulties are encountered in finding out the precise combination as between pigments, lacquer carrier substance and essential wavelength of the electromagnetic radiation. However, forgery is made even more difficult if the optically effective elements which in principle are already known as being difficult to forge are additionally present. That applies in particular if a colored halftone image according to the invention and an optically effective structure are immediately adjacent or in mutually nested relationship, in a single security element. Production processes are required here, which make copying practically impossible. In addition the safeguard and checking options are further enhanced. It would be possible for example to represent identical or mutually supplemental patterns with the halftone image on the one hand and the optically effective element on the other hand, and that affords additional checking options, either with normal illumination or when entailing illumination with light of a special wavelength, in which respect those checking options can certainly be such that they can also be easily understood by an unpractised observer.

As can be seen from the foregoing halftone images according to the invention can be used in an extremely versatile manner. It would also be possible for example for halftone prints of relatively large area to be produced on large-format printers in an embodiment according to the invention in order in that way to produce large-area, for example UV-fluorescent prints which can be used for special effects, for example in advertising. It would be possible for example to hang up in discotheques advertising placards or the like which are produced in accordance with the invention and the content of which can be recognised only upon irradiation with suitable light, for example UV radiation, wherein advertising placards of that kind differ from previously known elements which fluoresce under UV radiation, by virtue of the fact that halftone color images are actually obtained and this therefore affords extremely versatile design options. In spite of the options afforded the production costs for advertising means of that nature however are comparatively low.

Some basic principles and examples of halftone prints according to the invention are described in greater detail hereinafter.

If a halftone print is printed on a dark, preferably black, background, using printing inks with fluorescent pigments and if in that case the pigments are so selected that, with suitable irradiation, they light in the colors red, green and blue, it is then possible to produce a halftone image which in terms of its properties basically corresponds to the image produced by a TV picture tube, wherein in addition the individual image dots of the halftone image should be selected to be so small that they can no longer be individually resolved by the eye. That condition is met when viewing the halftone image from a normal reading distance, if the image dots are of a diameter of less than 0.3 mm, preferably even less than 0.1 mm. If in addition the image dots of the halftone image are printed so closely that the dark, preferably black, background no longer appears therethrough, it is possible to print halftone images which involve different properties. If it is assumed that UV-fluorescent pigments are used, which, upon radiation with normal daylight, do not light in a specific color, that provides that, under lighting with normal daylight, the halftone images appear as sheer black-and-white images (and more specifically by virtue of the natural coloring of the fluorescent pigments). If in contrast the halftone image is illuminated with suitable UV radiation, the pigments fluoresce in the respective colors, in which respect the pigments should preferably be selected appropriately in the sense of additive color mixing, so that they light up in red, green and blue. Then, depending on which image dots associated with the respective individual colors are present at a specific location of the halftone image and the density thereof, it is possible to generate a corresponding color image—similarly to the situation with a television picture tube—, wherein the dark or black background provides that it is also possible to produce dark image portions as, by additive color mixing, it is admittedly possible to produce the color white, but not the color black.

As already mentioned, particular effects can be achieved if at least one printing ink involves the use of pigments which fluoresce not only at one wavelength in the color which is characteristic of them, but which can also be excited with a second wavelength, in which case fluorescence then occurs in a second color. By way of example it would be possible to use pigments which are UV-fluorescent, more specifically on the one hand at the wavelength of 365 nm and on the other hand at the wavelength of 254 nm.

The halftone images can be produced using suitable printing inks in the usual printing processes, with offset printing (digital offset) or thermotransfer printing desirably being used. The use of those printing processes affords the advantage that, in those processes, the image information associated with each image (generally in the form of red, green and blue color components) can be used directly.

Examples of various pigment combinations in printing inks for producing corresponding halftone images are described hereinafter, in which respect for example the following pigments are used:

BF11 (red): bifluorescent pigment (red at 254 nm, blue-white at 365 nm)

Manufacturer: Specimen Document Security Division, Budapest CD 120 (red): monofluorescent pigment (orange-red at 154 nm, red at 365 nm)

Manufacturer: Allied Signal Special Chemicals Riedel De Haen

CD 130 (orange-yellow): monofluorescent pigment (orange at 254 nm and 365 nm)

Manufacturer: Allied Signal Special Chemicals Riedel De Haen

CD 397 (yellow-green): monofluorescent pigment (yellow-green at 254 nm and 365 nm)

Manufacturer: Allied Signal Special Chemicals Riedel De Haen

MF 1 (green): monofluorescent pigment (green at 254 nm and 365 nm)

Manufacturer: Specimen Document Security Division, Budapest

MF 40 (blue): monofluorescent pigment (blue at 254 nm and 365 nm)

Manufacturer: Specimen Document Security Division, Budapest

MF 50 (blue): monofluorescent pigment (pale blue at 154 nm, no fluorescence at 365 nm)

Manufacturer: Specimen Document Security Division, Budapest

Offset printing inks were produced using suitable pigments, wherein in per se known manner between 10 and 40 percent by weight of the UV-fluorescent pigment was ground together with an oxidatively drying offset varnish and used immediately.

If a corresponding thermotransfer foil with color layers with suitably fluorescent pigments is to be produced, then in per se known manner a thin PET-carrier is coated with a lacquer layer, into which the respectively desired fluorescent pigments are incorporated.

The following halftone prints were produced using the above-indicated pigments:

### EXAMPLE 1

Halftone print using red-green-blue on black, which can be excited at 365 nm:

| | |
|---|---|
| CD 120 | (red) |
| MF 1 | (green) |
| MF 40 | (blue) |

With uniform distribution or intensity of the three pigments used, irradiation with UV light of a wavelength of 365 nm gives white, by additive color mixing. In contrast, irradiation with UV light of a wavelength of 254 nm gives a pale orange because at that wavelength the pigment CD 120 is fluorescing not red but orange.

### EXAMPLE 2

Halftone print in red-green-blue on black, which can be excited at 254 nm:

| | |
|---|---|
| BF 11 | (red) |
| CD 397 | (yellow-green) |
| MF 50 | (blue) |

With uniform distribution, upon irradiation with UV light of a wavelength of 254 nm that gives the color white as a consequence of additive color mixing, whereas upon irradiation with UV light of a wavelength of 365 nm that gives the color green-white, more specifically because the pigment BF 11 fluoresces red only at 254 nm but in contrast it fluoresces blue-white at 365 nm. This means however that when the halftone image is designed for irradiation with UV light at a wavelength of 254 nm, it is possible to produce three-colour halftone printing, while upon irradiation with 365 nm the combination of Example 2 is only suitable for a kind of black-and-white printing.

### EXAMPLE 3

Halftone printing with black-and-white on black, which can be excited at 365 nm:

| | |
|---|---|
| BF 11 | (blue-white) |
| CD 130 | (orange-yellow) |

With suitably uniform distribution and intensity in respect of the printing inks containing the individual pigments, the color white is produced upon irradiation with UV light of a wavelength of 365 nm while the color red is produced upon irradiation with UV light of a wavelength of 254 nm. That is to be attributed to the fact that the bifluorescent pigment BF 11 is used. Therefore, upon irradiation with UV light of a wavelength of 365 nm halftone prints in accordance with Example 3 appear as black-and-white prints (the two color pigments in fact supplement each other to give white), while upon irradiation with UV light of a wavelength of 254 nm a red image is seen on a black background.

As the foregoing Examples show when using the basic concept of the invention, namely additive color mixing, by way of fluorescent pigments, it is possible to achieve a large number of color effects, in which respect color changes upon irradiation with light of differing wavelengths is particularly striking and for that reason particularly well suited as easily detectable security features. In accordance with the invention it is also advantageously possible to produce machine-readable security elements which can then be satisfactorily evaluated only by means of devices which produce the specific electromagnetic radiation which is required for excitation of the pigments and which can then differ considerably from the radiation of normal daylight.

### EXAMPLE 4

The pigments BF 11 (red, fluorescent at 254 nm), MF 1 (green, fluorescent at 254 nm) and MF 40 (blue, fluorescent at 254 nm) are used to produce a halftone image of a portrait on a substrate, wherein the spacing of the individual image dots is selected to be sufficiently great that further image dots can be inserted into the intermediate spaces. The size and spacing of the image dots however must be such that the individual image dots cannot be individually resolved with the naked eye at a normal viewing distance of about 30 cm.

Colored printing dots of suitably small size are printed into the intermediate spaces between the fluorescent image dots consisting of the pigments BF 11, MF 1 and MF 30, in which case those printing dots involve printing dots in the four primary colors for subtractive color mixing (generally cyan, yellow, magenta and black).

If in accordance with the foregoing proposal operation is to be implemented with six colors (or seven when using black), it is necessary under some circumstances to take care to ensure that no superimposition or moiré formation occurs in the printing. That can be achieved for example by the different representations being printed from fluorescent image dots on the one hand and normal-colored printing dots on the other hand, in different rasterings (for example 48 and 60 rasters). Another possibility would be that of using frequency-modulated rasters, instead of amplitude-modulated rasters, as is already usual nowadays in a large number of digital printers.

Both the printing dots with the fluorescent pigments and also the printing dots with normal printing inks are respectively arranged in such a way as to give a halftone image, in which respect for example the portrait of a person can be represented in both images. The selection of the colors for producing the halftone image is then such that, with normal lighting, for example with daylight or artificial light, the printing dots producing subtractive color mixing represent the first halftone color image of the person while the fluorescent printing dots, upon irradiation with suitable radiation, for example UV radiation, reproduce a substantially identical image. Checking of identity of the two images is a suitable means for checking authenticity.

1. A halftone image produced on a substrate by printing, comprising at least two kinds of image dots of different colors arranged in a raster-like manner, wherein the respectively desired color is produced by color mixing of the colors of the image dots, and provided on the substrate are on the one hand fluorescent image dots of printing inks containing pigments which fluoresce upon excitation with a given electromagnetic radiation and on the other hand non-fluorescent image dots of printing inks containing colored pigments which do not fluoresce upon excitation with the given electromagnetic radiation, wherein the fluorescent image dots on the one hand and the non-fluorescent image dots on the other hand are provided in mutually nested relationship on the substrate.

2. The halftone image as set forth in claim 1, wherein the fluorescent image dots represent a first image and the non-fluorescent image dots represent a second image.

3. The halftone image as set forth in claim 1, wherein there are provided image dots comprising three different printing inks, wherein the pigments of the various printing inks fluoresce in a respective one of three primary colors (for example red, green and blue-violet) for additive color mixing.

4. The halftone image as set forth in claim 1, wherein the pigments are UV-fluorescent pigments.

5. The halftone image as set forth in claim 1, wherein the image dots are arranged on a black background.

6. The halftone image as set forth in claim 1, wherein at least one of the pigments fluoresces in various colors under the effect of radiation of differing frequency.

7. The halftone image as set forth in claim 1, wherein the dimensions of the image dots are so selected that they cannot be resolved with the naked eye.

8. The halftone image as set forth in claim 7 wherein the dimensions of the image dots are selected to be smaller than 0.3 mm.

9. A security or guarantee element for valuables and documents, in particular value-bearing papers or bonds, banknotes, passes or articles comprises a halftone image produced on a substrate by printing, wherein said halftone image comprises at least two kinds of image dots of different colors arranged in a raster-like manner, wherein the respectively desired color is produced by color mixing of the colors of the image dots, and provided on the substrate are on the one hand fluorescent image dots of printing inks containing pigments which fluoresce upon excitation with a given electromagnetic radiation and on the other hand non-fluorescent image dots of printing inks containing colored pigments which do not fluoresce upon excitation with the given electromagnetic radiation, wherein the fluorescent image dots on the one hand and the non-fluorescent image dots on the other hand are provided in mutually nested relationship on the substrate.

10. The security or guarantee element for valuables and documents according to claim 9, wherein the halftone image is formed by the decorative layer of a transfer foil, which decorative layer is transferred on to the article to be safeguarded.

11. The security or guarantee element for valuables and documents according to claim 9, wherein the security or guarantee element further comprises an optically effective element.

12. The security or guarantee element for valuables and documents according to claim 9, wherein the fluorescent image dots represent a first image and the non-fluorescent image dots represent a second image.

13. The security or guarantee element for valuables and documents according to claim 9, wherein there are provided image dots comprising three different printing inks, wherein the pigments of the various printing inks fluoresce in a respective one of three primary colors (for example red, green and blue-violet) for additive color mixing.

14. The security or guarantee element for valuables and documents according to claim 9, wherein the pigments are UV-fluorescent pigments.

15. The security or guarantee element for valuables and documents according to claim 9, wherein the image dots are arranged on a black background.

16. The security or guarantee element for valuables and documents according to claim 9, wherein at least one of the pigments fluoresces in various colors under the effect of radiation of differing frequency.

17. The security or guarantee element for valuables and documents according to claim 9, wherein the dimensions of the image dots are so selected that they cannot be resolved with the naked eye.

18. The security or guarantee element for valuables and documents according to claim 9, wherein the dimensions of the image dots are selected to be smaller than 0.3 mm.
